(19) United States
(12) Patent Application Publication
(10) Pub. No.: US 2003/0227557 A1
(43) Pub. Date: Dec. 11, 2003

(54) Correction processing device of image data

(75) Inventors: Kazuhiko Okada, Kasugai (JP); Yoshiko Miura, Kasugai (JP); Nobuyuki Hattori, Kasugai (JP)

Correspondence Address: ARENT FOX KINTNER PLOTKIN & KAHN, 1050 CONNECTICUT AVENUE, N.W., SUITE 400, WASHINGTON, DC, 20036, US

(73) Assignee: FUJITSU LIMITED

(21) Appl. No.: 10/367,882

(22) Filed: Feb. 19, 2003

(30) Foreign Application Priority Data
Jun. 10, 2002 (JP) 2002-169047

(51) Int. Cl. H04N 5/217

(52) U.S. Cl. 348/241

(57) ABSTRACT

In an image sensing apparatus which generates image data corresponding to each pixel, a correction device which corrects the image data using correction data, includes a buffer memory which stores the correction data and the image data. An address control circuit generates write addresses for writing the correction data and the image data in the buffer memory such that the correction data and the image data corresponding to each pixel are sequentially read from the buffer memory.

### CROSS-REFERENCE TO RELATED APPLICATIONS

This application is based upon and claims the benefit of priority from the prior Japanese Patent Application No. 2002-169047, filed on Jun. 10, 2002, the entire contents of which are incorporated herein by reference.

### BACKGROUND OF THE INVENTION

The present invention relates to a correction processing device for image data, and more particularly, to a correction processing device for image data in an image recording apparatus such as a video camera or a digital still camera using an image sensing device, which is a charge coupled device (CCD) or a metal oxide semiconductor (MOS) type image sensor.

Conventionally, the following processing has been performed on image data that has been generated by a CCD or a MOS-type image sensor, in order to make the image data of higher quality. Since the image data includes noise components output from the image sensing device itself, it is required to remove the noise components for higher quality image data.

For example, in a digital still camera, at the time of sensing images, the camera is first set in a state where light is shielded by a shutter so that data including only the noise components is collected as correction data from the image sensing device, and the correction data is stored in a buffer memory. Second, the camera is set in a state where light transmits, and the image data is collected. At this time, an arithmetic operation is executed for removing the noise components from the image data based on the correction data read from the buffer memory, and the corrected image data is stored in the buffer memory as sensed image data. By the above correction processing, the image data (sensed image data) in which the noise components of the image sensing device has been removed is stored in the buffer memory. The sensed image data is recorded on recording media after various kinds of image processings are executed.

A synchronous dynamic random access memory (SDRAM) which operates at high speed for sequential access by which a write or read operation is continuously executed according to consecutive addresses, is preferably used for the buffer memory.

However, read operation of the correction data from the buffer memory and write operation of the sensed image data after correction are mixed in the image sensing apparatus when the noise components of the image sensing device are removed. Accordingly, efficiency in access to the buffer memory is not good, requiring more time for the noise correction processing. Moreover, in some cases, accurate sensed image data cannot be generated as some of the correction data or the image data is lost when the correction data or the image data is collected.

### SUMMARY OF THE INVENTION

In a first aspect of the present invention, a device for correcting image data is provided. The device removes a noise component from the image data using the image data and correction data corresponding to each of a plurality of pixels. The device includes a buffer memory which stores the correction data and the image data, a writing device connected to the buffer memory, which writes the correction data and the image data in the buffer memory, and a reading device connected to the buffer memory. The reading device reads the correction data and the image data from the buffer memory. The writing device includes a writing control circuit for controlling writing of the correction data and the image data in the buffer memory such that the reading device can read the correction data and the image data corresponding to each pixel from the buffer memory in a sequential manner.

In a second aspect of the present invention, an apparatus for correcting image data is provided. The apparatus removes a noise component from the image data, using the image data and the correction data corresponding to each of a plurality of pixels. The apparatus includes a buffer memory which stores the correction data and the image data, a processing unit which generates initial values of write addresses for the correction data and the image data written in the buffer memory and generates initial values of read addresses for the correction data and the image data read from the buffer memory, and an address control circuit which is connected to the processing unit and the buffer memory. The address control circuit generates write addresses for writing the correction data and the image data in the buffer memory, using the initial values of write addresses such that the correction data and the image data corresponding to each pixel are sequentially read from the buffer memory.

In a third aspect of the present invention, an apparatus for correcting image data is provided. The apparatus removes noise components from the image data using the image data and correction data corresponding to each of a plurality of pixels. The apparatus includes a buffer memory which stores the correction data and the image data, a processing unit which generates write addresses of the correction data and the image data written in the buffer memory, and generates read addresses of the correction data and the image data read from the buffer memory, wherein the processing unit further generates a data masking command signal, and a data masking signal generation circuit which is connected to the processing unit and the buffer memory. The data masking signal generation circuit supplies a data masking signal to the buffer memory in accordance with the data masking command signal such that the correction data and the image data of each of the pixels are written at the same addresses of the buffer memory.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic block diagram of an image sensing apparatus which comprises a correction processing device for image data according to a first embodiment of the present invention;

FIG. 2 is a diagram for explaining data which is stored in a buffer memory of the correction processing device shown in FIG. 1;

FIGS. 3A through 3C are timing charts showing operation of the correction processing device shown in FIG. 1;

FIG. 4 is a schematic block diagram of an image sensing apparatus which comprises a correction processing device for image data according to a second embodiment of the present invention;

FIG. 5 is a diagram for explaining data which is stored in a buffer memory of the correction processing device shown in FIG. 4;

FIGS. 6A through 6C are timing charts showing operation of the correction processing device shown in FIG. 4;

FIG. 7 is a schematic block diagram of an image sensing apparatus which comprises a correction processing device for image data according to a third embodiment of the present invention;

FIG. 8 is a diagram for explaining data which is stored in a buffer memory of the correction processing device shown in FIG. 7; and

FIG. 9 is a timing chart showing operation of the correction processing device shown in FIG. 7.

### DETAILED DESCRIPTION OF THE PREFERRED EMBODIMENTS

In the drawings, like numerals are used for like elements throughout.

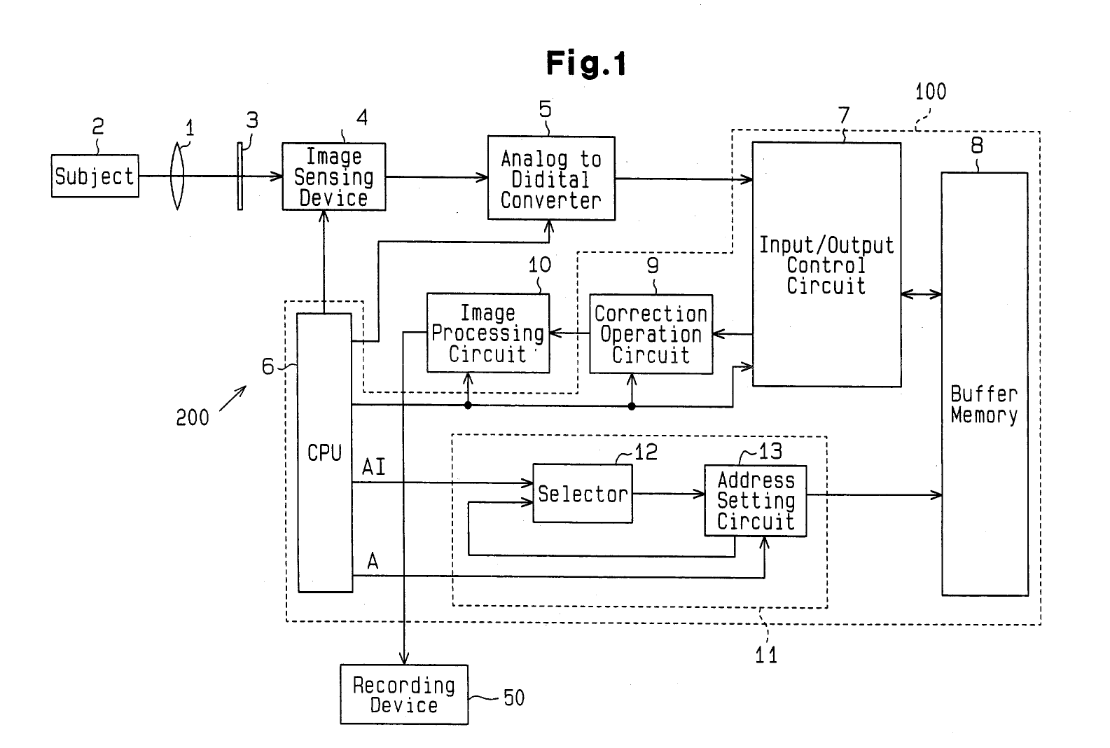

FIG. 1 is a schematic block diagram of an image sensing apparatus 200 (an image recording apparatus) which includes a noise correction processing device (a correction processing device for image data) 100 according to a first embodiment of the present invention. The image sensing apparatus 200 includes: a lens 1; a shutter 3; an image sensing device 4; an analog-to-digital converter 5; an image processing circuit 10; a recording device 50; and the noise correction processing device 100. The noise correction processing device 100 includes: a central processing unit (CPU) 6; an input/output control circuit 7; a buffer memory 8; a correction operation circuit 9; and an address control circuit 11 which functions as the image processing circuit 10 and a writing control circuit. The address control circuit 11 includes a selector 12 and an address setting circuit 13. The CPU 6 and the address control circuit 11 function as a data writing device and a data reading device.

The lens 1 outputs as an image light emitted from a subject 2 to the shutter 3. When the shutter 3 is open, the image captured through the lens 1 is supplied to the image sensing device 4. The image sensing device 4 is preferably a CCD or a MOS-type image sensor having a number of pixels. Each pixel converts the light caught through the lens 1 into electric charges, and the image sensing device 4 generates an analog image signal based on the charges.

When the shutter 3 is shut and the image sensing apparatus 200 is in a state that light is shielded, the image sensing device 4 generates an analog correction signal for noise correction based on the charge generated by each pixel in the state that light is shielded. The charges generated in the state that light is shielded are the noise components of each pixel. The CPU 6 controls generation of the analog image signal and the analog correction signal by the image sensing device 4.

The analog-to-digital converter 5 receives the analog correction signal and the analog image signal from the image sensing device 4, the analog correction signal is converted according to control of the CPU 6 into correction data which is a digital signal, and the analog image signal is converted into image data which is a digital signal.

The input/output control circuit 7 receives the correction data and the image data from the analog-to-digital converter 5 according to control of the CPU 6, and the correction data and the image data are supplied to the buffer memory 8 at the time of the write operation. Moreover, the input/output control circuit 7 supplies the correction data and the image data, which are read from the buffer memory 8, to the correction operation circuit 9.

Preferably, the buffer memory 8 is of an SDRAM. In the first embodiment, 16-bit data is read from the buffer memory 8 according to one column address signal in a burst mode.

The correction operation circuit 9 receives the correction data and the image data, which have been read from the buffer memory 8 according to control of the CPU 6, through the input/output control circuit 7 and generates sensed image data in which the noise components have been removed from the image data, based on the correction data and image data.

The image processing circuit 10 receives the sensed image data from the correction operation circuit 9 according to control of the CPU 6, and generates data for recording by performing an image processing such as the joint photographic experts group (JPEG) on the sensed image data.

The recording device 50 receives the data for recording from image processing circuit 10 and records it on recording media such as a magnetic disk (not shown).

The address control circuit 11 generates a write address, which is used when the correction data and the image data are written in the buffer memory 8 according to control of the CPU 6, and a read address, which is used when the correction data and the image data are read.

The selector 12 in the address control circuit 11 receives an initial value AI of an address supplied from the CPU 6 and supplies a selector output signal, which is an address value including the initial value AI, to the address setting circuit 13.

The initial value AI of the address is set as “0” when the correction data is written in the buffer memory 8, and is set as “1” when the image data is written in the buffer memory 8. Also, the initial value AI of the address is set as “0” at the time of the operation in which the correction data and the image data are read.

An increasing-address-number command signal A is supplied from the CPU 6 to the address setting circuit 13. The increasing-address-number command signal A is set as “+2” when the correction data and the image data are written in the buffer memory 8, and the signal A is set as “+1” when the correction data and the image data are read from the buffer memory 8.

The address setting circuit 13 supplies the address value supplied from the selector 12 to the buffer memory 8 as a column address signal, the value of the increasing-address-number command signal A is added to the address value, and the added address value is supplied to the selector 12.

The selector 12 receives the added address value, which is supplied from the address setting circuit 13, in response to a rising clock signal, after the initial value supplied from the CPU 6 is supplied to the address setting circuit 13, and supplies the added address value to the address setting circuit 13.

In the first embodiment, address values “0, 2, 4, 6 . . . ” are supplied to the buffer memory 8 from the address control circuit 11 in the write operation of the correction data. Also, address values “1, 3, 5, 7 . . . ”, are supplied to the buffer memory 8 from the address control circuit 11 at the time of the write operation of the image data. Moreover, address values “0, 1, 2, 3, 4, 5, 6 . . . ” are supplied to the buffer memory 8 from the address control circuit 11 at the time of the read operation of the correction data and the image data. In this manner, the CPU 6 and the address control circuit 11 are operated as the data writing device and the data reading device.

Next, the operation of the noise correction processing device 100 will be explained.

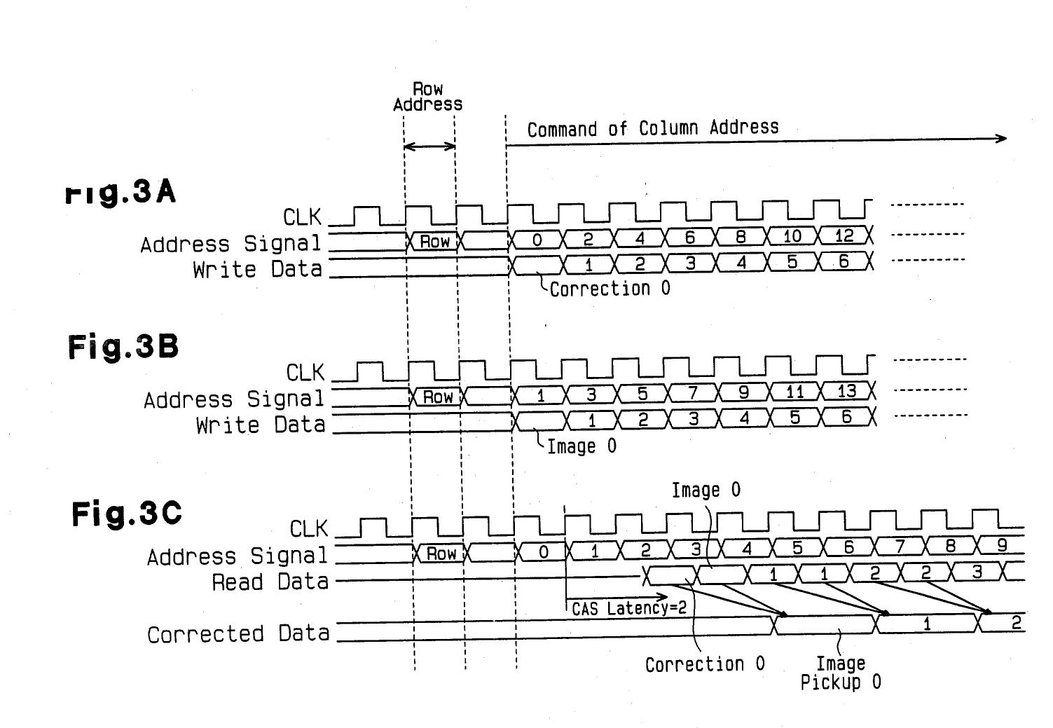

First, when the analog correction signal is generated in the image sensing device 4 in a state where the shutter 3 is shut, the analog-to-digital converter 5 converts the analog correction signal into the correction data which is a digital signal, and the input/output control circuit 7 stores the correction data in the buffer memory 8. At this time, the increasing-address-number command signal A “+2” is supplied from the CPU 6 to the address control circuit 11. Accordingly, as shown in FIG. 3A, a row address ROW is selected in accordance with a clock signal CLK in the buffer memory 8, and then the correction data is written sequentially at an address selected according to the column address signal supplied from the address control circuit 11. At this time, the address values of the column address signals are 0, 2, 4, 6 . . . . For example, correction data of 16 bits for one pixel is stored at each selected address, and correction data 0 to n−1 corresponding to the number of the pixels n of the image sensing devices 4, are sequentially written at the selected addresses. At this time, a burst length in an operation mode of the buffer memory 8 is set as “1”.

Subsequently, image data is collected a state where the shutter 3 is open. At this time, as shown in FIG. 3B, the same row address ROW as that used at the time of writing of the correction data is selected according to the clock signal CLK in the buffer memory 8. Then, image data is sequentially written at addresses selected according to the column address signal supplied from the address control circuit 11. At this time, the address values of the column address signals are 1, 3, 5, 7 . . . . For example, image data of 16 bits for one pixel is stored at each selected address, and the image data 0 to n−1, corresponding to the number of the pixels n of the image sensing devices 4, are sequentially written at the selected addresses.

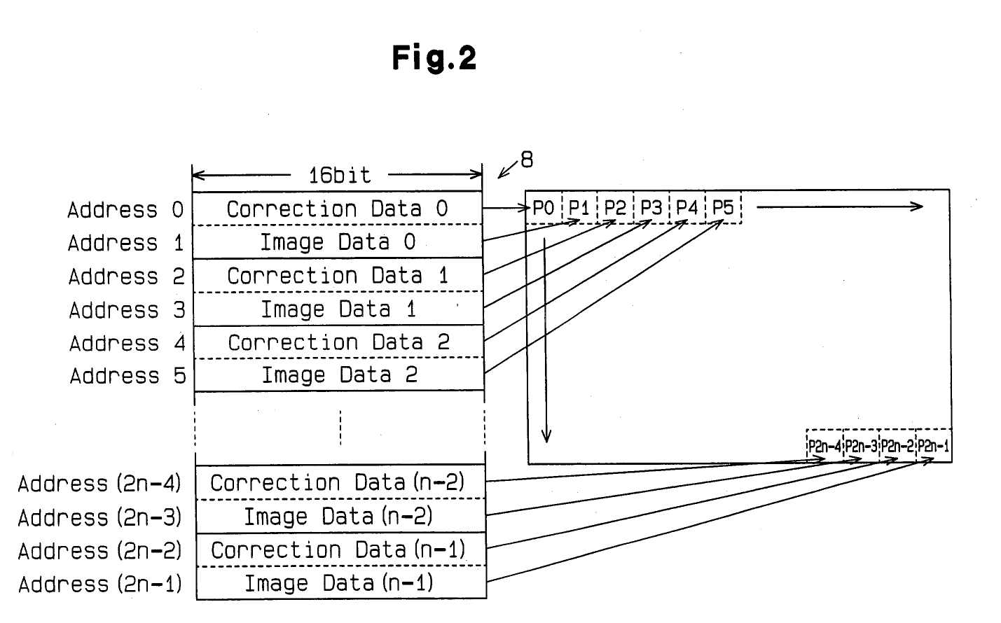

The correction data and the image data for n pieces of pixels P0 to Pn−1 are stored, by such a write operation, in consecutive addresses 0 to 2n−1 of the buffer memory 8 as shown in FIG. 2.

Subsequently, an increasing-address-number command signal A “+1” is supplied from the CPU 6 to the address control circuit 11 in order to execute the arithmetic operation of the sensed image data in the correction operation circuit 9, based on the correction data and the image data. At this time, as shown in FIG. 3C, the same row address ROW as that used at the time of writing of the correction data and the image data is selected according to the clock signal CLK in the buffer memory 8. Then, the correction data and the image data corresponding to each pixel P0 to Pn−1 are sequentially read from addresses 0 to 2n−1 which are selected according to the column address signals supplied from the address control circuit 11. At this time, the column address strobe (CAS) latency has been set as “2”. The correction operation circuit 9 sequentially generates the sensed image data 0 to n−1 which is the data after the correction, based on the correction data and the image data which have been read, and transfers the sensed image data 0 to n−1 to the image processing circuit 10.

The noise correction processing device 100 according to the first embodiment has the following advantages:

(1) When the correction data and the image data are provided from the image sensing device 4, only the write operation for the correction data and the image data in the buffer memory 8 is executed. Accordingly, as only a sequential operation is executed with respect to the buffer memory 8, the operation for collecting the correction data and the image data is executed at high speed.

(2) The correction data and the image data corresponding to each pixel of the image sensing devices 4 are stored at the consecutive addresses of the buffer memory 8. Accordingly, the correction operation circuit 9 sequentially reads, from the consecutive addresses of the buffer memory 8, the correction data and the image data corresponding to each pixel in the arithmetic operation processing of the sensed image data. As a result, since the sequential read operation from the buffer memory 8 is executed at generation of the sensed image data, the read operation is executed at high speed.

(3) Since efficiency of access to the buffer memory 8 is improved, access time to the buffer memory 8 is secured for other processing except writing and reading operations of the correction data and the image data. Accordingly, access to the buffer memory is easily executed at the time of storage of sensed image data, which has been generated in the correction operation circuit 9, in the buffer memory 8 or at the time of transfer of data generated in the image processing circuit 10 to recording media.

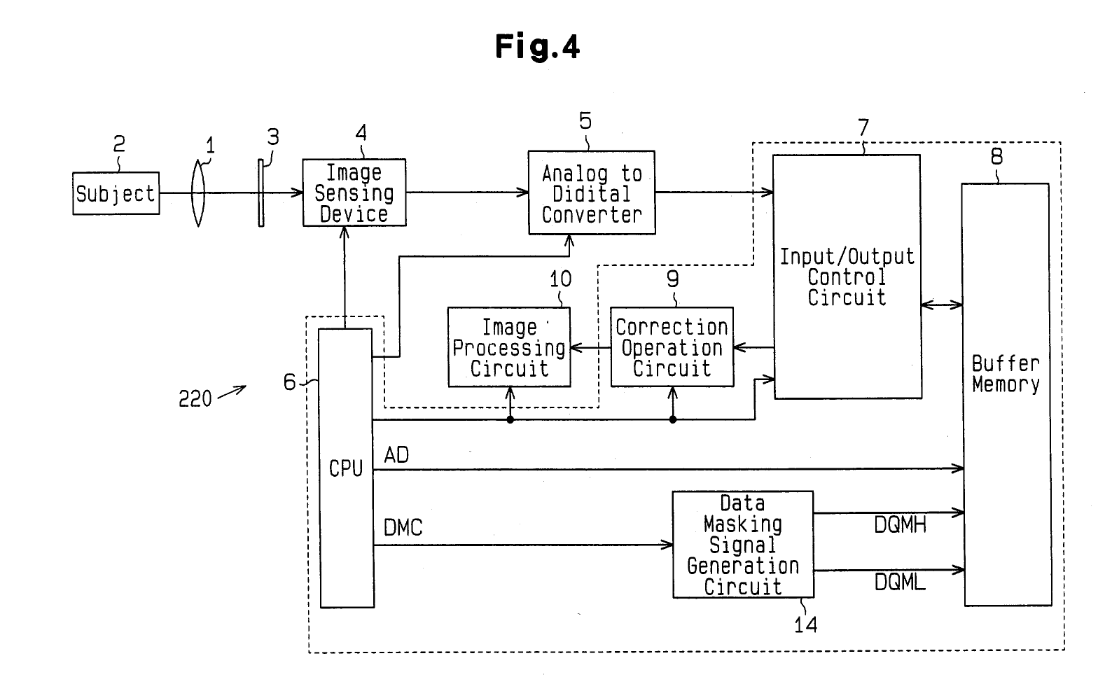

FIG. 4 is a schematic block diagram of an image sensing apparatus 220 which includes a noise correction processing device 120 according to a second embodiment of the present invention. In the second embodiment, the noise correction processing device 120 includes a data masking signal generation circuit 14, instead of the address control circuit 11, which functions as a writing control circuit.

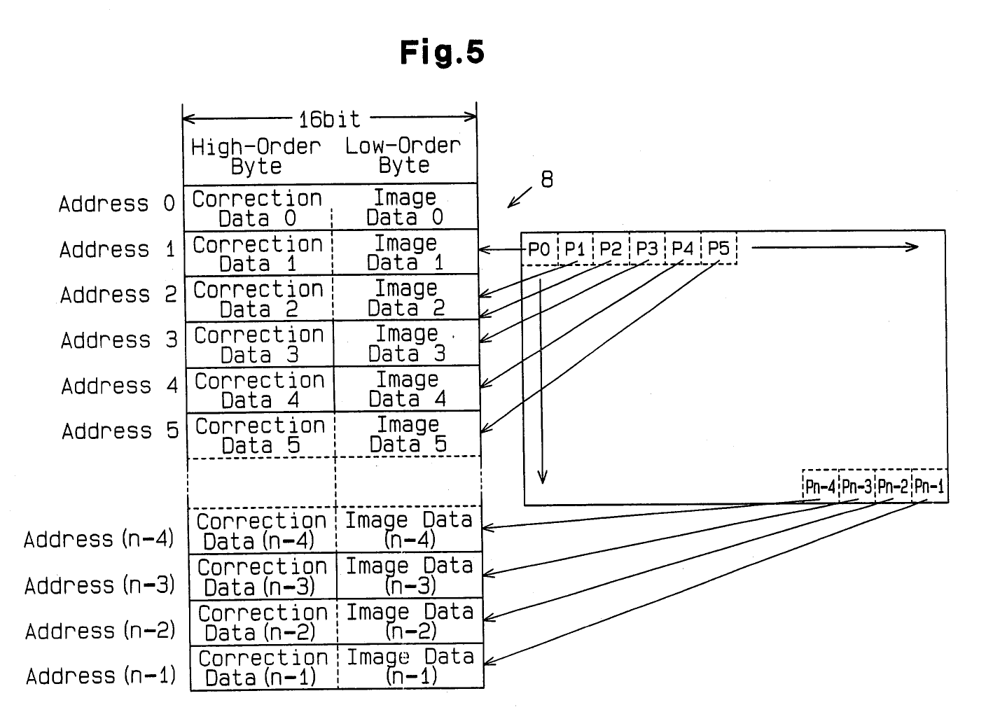

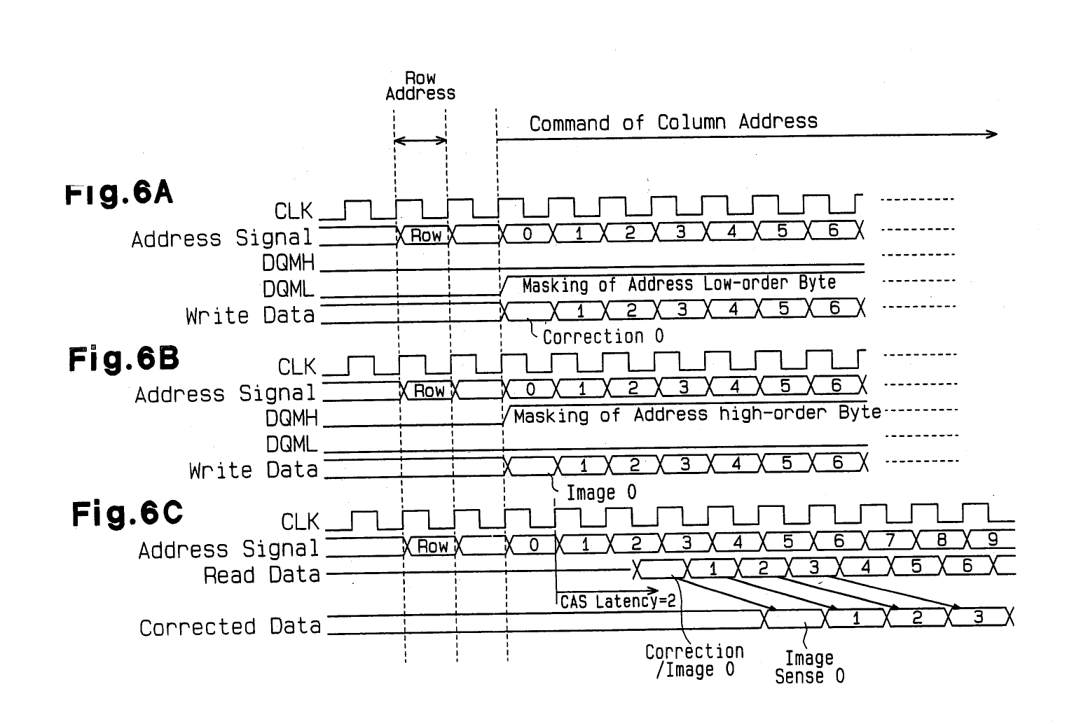

In the second embodiment, when the correction data or the image data is written in a buffer memory 8, consecutive address signals AD starting with an address “0” are supplied from the CPU 6 to the buffer memory 8 as shown in FIGS. 5, 6A, and 6B. Also, when the correction data and the image data are read from the buffer memory 8, consecutive address signals starting with an address “0” are supplied from the CPU 6 to the buffer memory 8.

The CPU 6 supplies a data masking command signal DMC to the data masking signal generation circuit 14 when the correction data or the image data are written in the buffer memory 8.

The data masking signal generation circuit 14 supplies a data masking signal DQML of a high (H) level to the buffer memory 8, in response to the data masking command signal DMC, at the time of the write operation of the correction data. The buffer memory 8 masks low-order 8 bit storage cells among 16-bit storage cells selected in each address, and writes the correction data in high-order 8 bit storage cells according to the H-level data masking signal DQML as shown in FIG. 5.

The data masking signal generation circuit 14 supplies an H-level data masking signal DQMH to the buffer memory 8, responding to the data masking command signal DMC, at the time of the write operation of the image data. The buffer memory 8 masks high-order 8 bit storage cells among 16-bit storage cells selected at each address, and writes the image data in low-order 8 bit storage cells according to the H-level data masking signal DQMH as shown in FIG. 5. In the second embodiment, the CPU 6 and the data masking signal generation circuit 14 function as a writing device, and the CPU 6 functions as a reading device.

Next, the operation of the noise correction processing device 120 will be explained.

First, an analog correction signal, which has been generated in an image sensing device 4 when the shutter 3 is shut, is converted by an analog-to-digital converter 5, into the correction data which is of a digital signal, and the correction data is stored in the buffer memory 8 through the input/output control circuit 7. More specifically, as shown in FIG. 6A, a row address ROW is selected in the buffer memory 8 according to a clock signal CLK. Subsequently, the correction data is sequentially written at addresses starting from the address “0” according to a column address signal supplied from the CPU 6. At this time, since the H-level data masking signal DQML is supplied from the data masking signal generation circuit 14 to the buffer memory 8, low-order bytes of each address are masked and the correction data are sequentially written in the high-order bytes at that address as shown in FIG. 5. That is, the correction data 0 to n−1 corresponding to each pixel P0 to Pn−1 respectively are written in the high-order 8 bits at that address. In this manner, for example, the 8-bit correction data for one pixel is stored at each address which has been selected, and the correction data 0 to n−1 corresponding to the number of pixels n of the image sensing devices 4 are sequentially written in the high-order bytes at the consecutive addresses 0 to n−1. At this time, the burst length of the buffer memory 8 is arbitrary.

Subsequently, image data is collected in a state where the shutter 3 is open. Then, as shown in FIG. 6B, the same row address ROW as that used at the time of writing of the correction data is selected according to the clock signal CLK in the buffer memory 8. Subsequently, a column address signal is supplied from the CPU 6, and the image data is sequentially written at addresses starting from the address “0” according to the column address signal. At this time, since the H-level data masking signal DQMH is supplied from the data masking signal generation circuit 14 to the buffer memory 8, high-order bytes of each address are masked and the image data is sequentially written in the low-order bytes at that address as shown in FIG. 5. That is, the image data each corresponding to each pixel is written in the low-order 8 bits at each address. Thus, for example, image data of 8 bits for one pixel are each stored at the selected address, and the image data 0 to n−1 corresponding to the number of the pixels n of the image sensing devices 4, are sequentially written in the low-order bytes at the consecutive addresses 0 to n−1.

As a result of such a write operation, the correction data and the image data of n pieces of pixels P0 to Pn−1 are stored at consecutive addresses 0 to n−1 in the buffer memory 8, as shown in FIG. 5.

Subsequently, as shown in FIG. 6C, the same row address ROW as that used at the time of writing of the correction data and the image data is selected according to the clock signal CLK in the buffer memory 8 in order to generate sensed image data in the correction operation circuit 9, based on the correction data and the image data. Subsequently, consecutive addresses 0 to n−1 are selected according to the column address signal supplied from the CPU 6, and the correction data and the image data corresponding to each pixel P0 to Pn−1 are sequentially read, respectively, from all bits of the consecutive address 0 to n−1. At this time, the CAS Latency has been set as “2”. The correction operation circuit 9 sequentially generates the sensed image data 0 to n−1, which is data after the correction, based on the correction data and the image data which have been read.

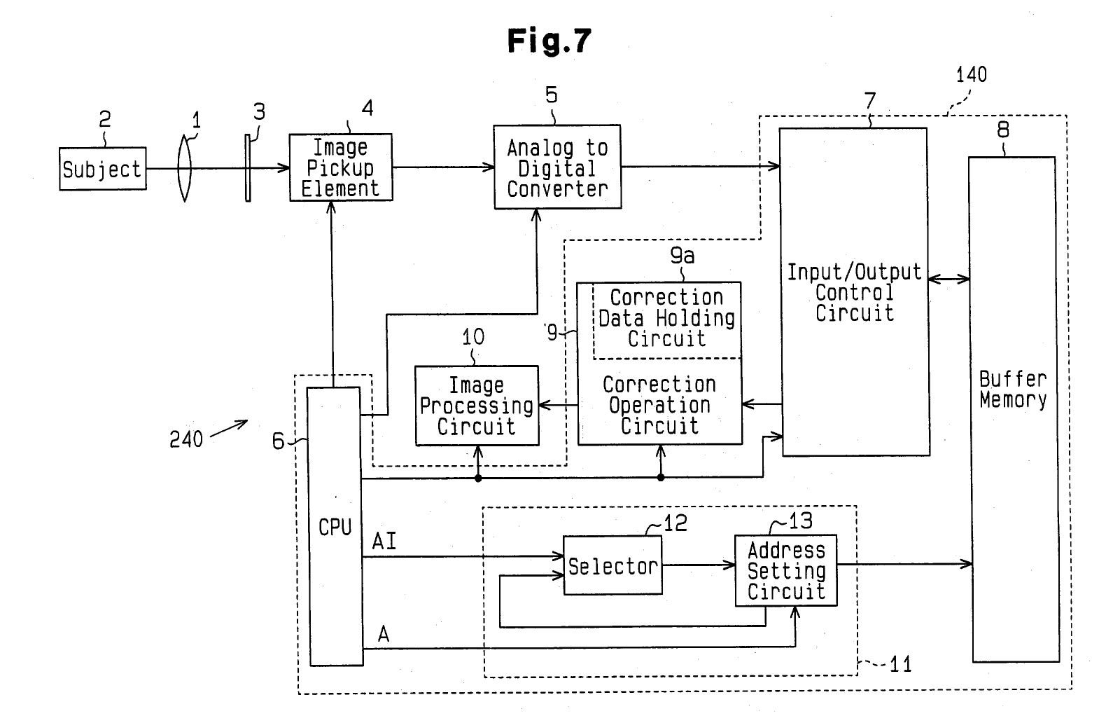

FIG. 7 is a schematic block diagram of an image sensing apparatus 240 which comprises a noise correction processing device 140 according to a third embodiment of the present invention. In the third embodiment, the correction operation circuit 9 comprises a correction data holding circuit 9a, and address setting in an address control circuit 11 is changed.

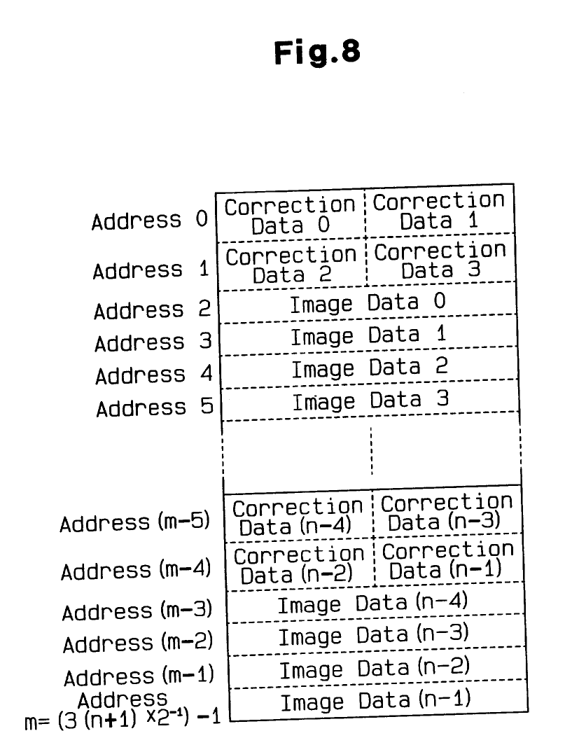

As shown in FIG. 8 in the third embodiment, the correction data which has a number of bits half that of the image data is stored in the buffer memory 8. Since the correction data is obtained in a state where light is shielded, the data amount of the correction data is sufficient even if the number of bits of the correction data is small.

When the correction data holding circuit 9a reads the correction data from the buffer memory 8, the correction data holding circuit 9a temporarily holds the correction data. Preferably, a register is used as the correction data holding circuit 9a.

At the time of the write operation of the correction data, the CPU 6 supplies an initial value AI “0” of an address to a selector 12, and increasing-address-number command signals A “+1, +5, +1, +5, +1”, the values of which are changed alternately at each cycle of a clock signal CLK.

Also, at the time of write operation of the image data, the CPU 6 supplies an initial value AI “2” of an address to the selector 12, and increasing-address-number command signals A “+1, +1, +1, +3, +1, +1, +1, +3”, the values of which are changed according to a predetermined cycle pattern of the clock signal CLK. In the third embodiment, the CPU 6 and the address control circuit 11 function as a writing device, and the CPU 6, the address control circuit 11, and the correction data holding circuit 9a function as a reading device.

Next, the operation of the noise correction processing device 140 will be explained.

First, an analog correction signal, which has been generated in the image sensing device 4 when the shutter 3 is shut, is converted, by an analog-to-digital converter 5, into the correction data which is of a digital signal, and the correction data is stored in the buffer memory 8 through the input/output control circuit 7. At this time, the CPU 6 supplies an initial value AI “0” of an address to the selector 12, and increasing-address-number command signals A “+1, +5, +1, +5, +1”, the values of which are changed alternately at each cycle of the clock signal CLK, are supplied to an address setting circuit 13.

Thereby, the correction data 0 and 1 of pixels P0 and P1 are stored at an address “0” at a first cycle of the clock signal, and the correction data 2 and 3 of pixels P2 and P3 are stored at an address “1” at a second cycle of the clock signal according to the increasing-address-number command signal A “+1”. Also, the correction data 4 and 5 of pixels P4 and P5 are stored at an address “6” at a third cycle of the clock signal according to the increasing-address-number command signal A “+5”, and the correction data 6 and 7 of pixels P6 and P7 are stored at an address “7” at a fourth cycle of the clock signal according to the increasing-address-number command signal A “+1”. Thus, the correction data 0 to n−1 for n pieces of pixels are sequentially stored at the buffer memory 8.

Subsequently, in a state where the shutter 3 is open, image data is collected. At this time, the CPU 6 supplies an initial value AI “2” of an address to the selector 12, and increasing-address-number command signals A “+1, +1, +1, +3, +1, +1, +1, +3”, the values of which are changed according to a predetermined cycle pattern of the clock signal CLK, are supplied to the address setting circuit 13.

Thereby, as shown in FIG. 8, the image data 0 of a pixel P0 is stored at an address “2” at the first cycle of the clock signal, and the image data 1 of a pixel P1 is stored at an address “3” at the second cycle of the clock signal according to the increasing-address-number command signal A “+1”. Thus, the image data 0 to n−1 for n pieces of pixels are sequentially stored in the buffer memory 8 at each address.

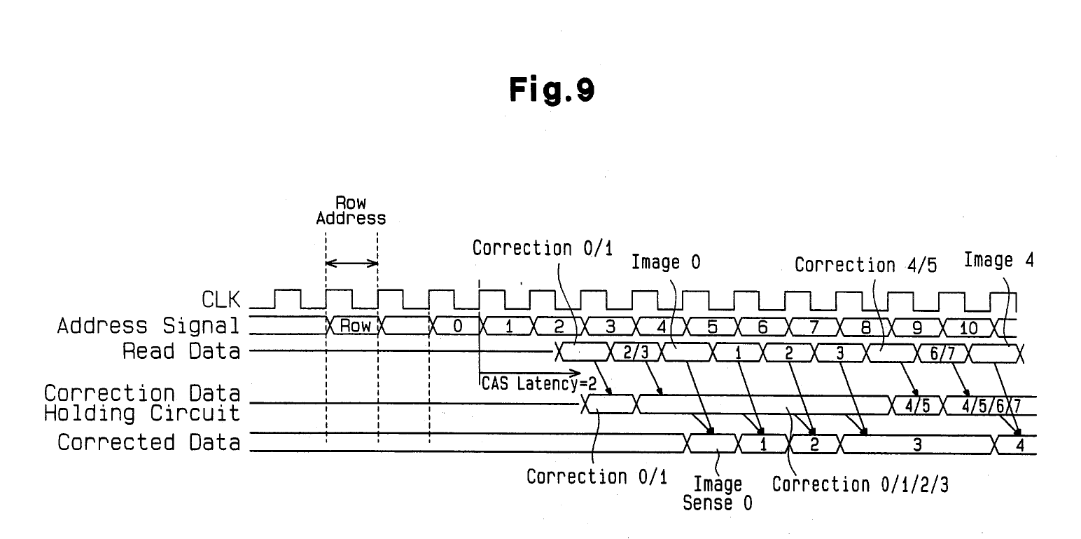

Subsequently, the CPU 6 supplies the initial value AT “0” of an address and the increasing-address-number command signal A “+1” to the address control circuit 11 in order to generate sensed image data in the correction operation circuit 9, based on the correction data and the image data which have been stored in the buffer memory 8. Then, as shown in FIG. 9, the same row address ROW as that used at the time of writing of the correction data and the image data is selected according to the clock signal CLK in the buffer memory 8.

Subsequently, column address signals are continuously supplied from the address control circuit 11 to the buffer memory 8, and the correction data and the image data corresponding to pixels P0 to Pn−1 are sequentially read from the consecutive column addresses. At this time, for example, four pieces of correction data 0 to 3, which have been read from addresses “0” and “1” of the buffer memory 8, are temporarily held in the correction data holding circuit 9a of the correction operation circuit 9. When pieces of the image data 0 to 3 are read from addresses “2 to 5” in the above state, the correction operation circuit 9 generates sensed image data 0 to 3, based on the correction data 0 to 3, which have been held in the correction data holding circuit 9a, and read image data 0 to 3. Thus, the correction operation circuit 9 sequentially generates sensed image data 0 to n−1.

In the third embodiment, since the correction data for two pixels are stored at each address, the storage areas of the correction data in the buffer memory 8 are reduced.

It should be apparent to those skilled in the art that the present invention may be embodied in many other specific forms without departing from the spirit or scope of the invention. Particularly, it should be understood that the invention may be embodied in the following forms.

In the above three embodiments, the correction data may be collected after the image data has been collected.

In the second embodiment, the image data may be stored in the high-order bytes, and the correction data may be stored in the low-order bytes.

Therefore, the present examples and embodiments are to be considered as illustrative and not restrictive and the invention is not to be limited to the details given herein, but may be modified within the scope and equivalence of the appended claims.

What is claimed is:

1. A device for correcting image data by removing a noise component from the image data, using the image data and correction data corresponding to each of a plurality of pixels, the device comprising:
a buffer memory which stores the correction data and the image data;
a writing device connected to the buffer memory, which writes the correction data and the image data in the buffer memory; and
a reading device connected to the buffer memory, which reads the correction data and the image data from the buffer memory, wherein the writing device includes a writing control circuit for controlling writing of the correction data and the image data in the buffer memory such that the reading device can read the correction data and the image data corresponding to each pixel from the buffer memory in a sequential manner.

2. The device according to claim 1, wherein the writing device comprises a processing unit which sets a starting address for writing the correction data and the image data in the buffer memory, and wherein the writing control circuit comprises an address setting circuit which generates an address signal following the starting address for writing the correction data and the image data, using the starting address.

3. The device according to claim 2, wherein the address setting circuit generates an address signal such that the correction data and the image data corresponding to each of the pixels are written in consecutive addresses of the buffer memory.

4. The device according to claim 2, wherein the address setting circuit generates an address signal such that the correction data and the image data are alternately written in the buffer memory in units of pixels, and wherein the reading device comprises a correction data holding circuit which temporarily holds the correction data read from the buffer memory.

5. The device according to claim 4, wherein the correction data for two pixels are written in one address of the buffer memory.

6. The device according to claim 1, wherein the writing device comprises a processing unit which generates an address signal for writing the correction data and the image data in the buffer memory and supplies a data masking command signal to the writing control circuit, and wherein the writing control circuit comprises a data masking signal generation circuit which supplies a data masking signal in the buffer memory in accordance with the data masking command signal such that the correction data and the image data of each of the pixels are written at the same address of the buffer memory.

7. An apparatus for correcting image data by removing a noise component from the image data, using the image data and the correction data corresponding to each of a plurality of pixels, the apparatus comprising:
a buffer memory which stores the correction data and the image data;
a processing unit which generates initial values of write addresses for the correction data and the image data written in the buffer memory and generates initial values of read addresses for the correction data and the image data read from the buffer memory; and
an address control circuit which is connected to the processing unit and the buffer memory and generates write addresses for writing the correction data and the image data in the buffer memory, using the initial values of write addresses such that the correction data and the image data corresponding to each pixel are sequentially read from the buffer memory.

8. The apparatus according to claim 7, wherein the address control circuit generates a write address for writing the correction data and the image data alternately in units of one pixel, using the initial values of write addresses.

9. The apparatus according to claim 7, wherein the address control circuit generates a write address for writing the correction data and the image data alternately in units of a predetermined number of pixels, using the initial values of write addresses.

10. The apparatus according to claim 9, wherein the address control circuit generates a read address for reading the correction data and the image data from the buffer memory in units of a predetermined number of pixels, using the initial values of read addresses, and the device further comprises a correction data holding circuit which temporarily holds the correction data read from the buffer memory in units of a predetermined number of pixels.

11. The apparatus according to claim 9, wherein correction data for two pixels are written in one address of the buffer memory.

12. The apparatus according to claim 7, wherein the processing unit generates an initial value of a write address “0” for the correction data, an initial value of a write address “1” for the image data, and an initial value of read address “0” for the correction data and the image data,
the address control circuit continues to generate write addresses of the correction data while adding two to the initial value “0” of the write address, continues to generate write addresses of the image data while adding two to the initial value “1” of the write address, and further continues to generate read addresses of the correction data and the image data while adding one to the initial value “0” of the read address.

13. The apparatus according to claim 7, wherein the processing unit generates a first predetermined initial value of the write address for the correction data, a second predetermined initial value of the write address for the image data, and a third predetermined initial value of the read address for the correction data and the image data, and wherein the address control circuit continues to generate write addresses of the correction data while sequentially adding increasing numbers in a first predetermined increasing-number group to the first predetermined initial value of the write address, continues to generate write addresses of the image data while sequentially adding increasing numbers in a second predetermined increasing-number group to the second predetermined initial value of the write address, and, further continues to generate read addresses of the correction data and the image data while adding one to the third initial value of the read address.

14. The apparatus according to claim 13, wherein the increasing numbers in the first predetermined increasing-number group are alternately changed, and the increasing numbers in the second predetermined increasing-number group are changed according to a predetermined pattern.

15. An apparatus for correcting image data by removing noise components from the image data using the image data and correction data corresponding to each of a plurality of pixels, the apparatus comprising:
a buffer memory which stores the correction data and the image data;
a processing unit which generates write addresses of the correction data and the image data written in the buffer memory, and generates read addresses of the correction data and the image data read from the buffer memory, wherein the processing unit further generates a data masking command signal; and
a data masking signal generation circuit which is connected to the processing unit and the buffer memory, and supplies a data masking signal to the buffer memory in accordance with the data masking command signal such that the correction data and the image data of each of the pixels are written at the same addresses of the buffer memory.

16. The apparatus according to claim 15, wherein the buffer memory, in accordance with the data masking signal, masks a write area of image data at the same address as a write address of the correction data when the correction data is written, and masks a write area of the correction data at the same address as a write address of the image data when the image data is written.

17. An image recording apparatus comprising:
an image sensing device including a plurality of pixels, which generates image data corresponding to each pixel and correction data for correcting the image data; and
a correction device which receives the image data and the correction data and corrects the image data by removing a noise component from the image data using the image data and the correction data corresponding to each pixel, wherein the correction device includes:
a buffer memory, which stores the correction data and the image data;
a writing device connected to the buffer memory, which writes the correction data and the image data in the buffer memory; and
a reading device connected to the buffer memory, which reads the correction data and the image data from the buffer memory, wherein the writing device includes a writing control circuit, which controls writing of the correction data and the image data in the buffer memory such that the reading device reads the correction data and the image data corresponding to each pixel from the buffer memory in a sequential manner.

18. An image recording apparatus comprising:
an image sensing device including a plurality of pixels, which generates image data corresponding to each pixel and correction data for correcting the image data; and
a correction device which receives the image data and the correction data and corrects the image data by removing noise components from the image data using the image data and the correction data corresponding to each pixels, wherein the correction device includes:
a buffer memory which stores the correction data and the image data;
a processing unit which generates initial values of write addresses of the correction data and the image data written in the buffer memory, and initial values of read addresses of the correction data and image data read from the buffer memory; and
an address control circuit connected to the processing unit and the buffer memory, which generates write addresses of the correction data and the image data in the buffer memory using the initial values of the write addresses such that the correction data and the image data corresponding to each pixel are sequentially read from the buffer memory.

19. An image recording apparatus comprising:
an image sensing device including a plurality of pixels, which generates correction data for correcting image data corresponding to each pixel and correction data for correcting the image data; and
a correction device which receives the image data and the correction data and corrects the image data by removing noise components from the image data, using the image data and the correction data corresponding to each pixel, wherein the correction device includes:
a buffer memory which stores the correction data and the image data;
a processing unit which generates write addresses of the correction data and the image data written in the buffer memory, and read addresses of the correction data and image data read from the buffer memory, wherein the processing unit further generates a data masking command signal; and
a data masking signal generation circuit connected to the processing unit and the buffer memory, which supplies a data masking signal to the buffer memory in accordance with the data masking command signal such that the correction data and the image data of each of the pixels are written at the same address of the buffer memory.
